(19) United States
(12) Patent Application Publication
(10) Pub. No.: US 2005/0241958 A1
(43) Pub. Date: Nov. 3, 2005

(54) Ion-selective electrode sensors

(76) Inventor: Jungwon Shin, Waltham, MA (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(21) Appl. No.: 10/833,691

(22) Filed: Apr. 28, 2004

(51) Int. Cl. G01N 27/26

(52) U.S. Cl. 205/779; 204/416; 204/418; 205/792

(57) ABSTRACT

The present invention provides ion-selective electrode (ISE) sensors for detecting one or more analytes in a sample that includes an electrode and an ion-selective membrane, wherein the ion selective membrane contains an epoxy resin and one or more amine curing agents. The invention also provides methods of making and using such ISE sensors.

### TECHNICAL FIELD

The present invention is related to the field of ion-selective electrode sensors, particularly to ion-selective electrode sensors containing polymeric ion-selective membranes.

### BACKGROUND INFORMATION

Ion-selective electrode (ISE) sensors are often used to detect and/or measure analytes in biological samples, such as blood, serum, plasma, cerebro-spinal fluid, saliva, and urine. Such sensors often include a semi-permeable polymeric membrane that contains an ion-selective agent that selectively binds or associates with particular ions, producing a measurable electrical response. Because biological samples can contain low concentrations of ionic species, an ISE sensor should have high sensitivity for the analyte of interest. In addition, biological samples generally contain other substances, for example, other ionic species, that can interfere with the measurement of the analyte of interest. Another requirement of an ISE sensor, therefore, is to achieve a high degree of selectivity toward an analyte of interest in the presence of interfering species. The sensitivity and selectivity of an ISE sensor depends upon the composition of the polymeric membrane.

Typical ISE sensor membranes are made of polyvinyl chloride (PVC) and an ion-selective agent. To achieve a high degree of selectivity for ions, such as chloride ions, for example, PVC-based membranes can include a high percentage (e.g., 50-90% by weight) of an ion-selective agent, such as a quaternary ammonium salt. However, a high concentration of quaternary ammonium salts imparts a high charge density to the PVC-based membrane, which makes the surface of the membrane susceptible to the formation of deposits, such as protein deposits. As a result, the membrane must be cleaned often during use, which can be costly and time consuming.

To address this problem, epoxy resins, which are resistant to protein buildup, have been used in membranes for ISE sensors. One type of membrane includes a mixture of an epoxy resin, a curing agent, and PVC, to which other additives, including quaternary ammonium salts, have been added. It was believed that the quaternary ammonium salt additives were necessary to impart ionic selectivity to the polymeric membrane. Another approach involves an essentially PVC-free membrane made of an epoxy resin, an amino compound as a curing agent, and a flexibilizer, such as propylene glycoldiglycidyl ether or cresyl ether, which was believed necessary to decrease the resistance of the membrane. Each of these approaches requires at least one additive in addition to an epoxy resin and a curing agent, which can increase the complexity and cost of producing these ISE sensors.

There is therefore a need for an ISE sensor that has high selectivity and sensitivity for an analyte of interest which can be produced in a simple and cost-effective manner.

### SUMMARY OF THE INVENTION

Throughout the description, where compositions are described as having, including, or comprising specific components, or where processes are described as having, including, or comprising specific steps, it is contemplated that compositions of the invention also consist essentially of, or consist of, the recited components, and that the processes of the invention also consist essentially of, or consist of, the recited steps.

The present invention provides a sensor that exhibits high levels of selectivity and sensitivity for ionic species in a biological sample. The sensor is resistant to protein deposits and accurately measures ion concentrations in biological samples without significant deterioration in performance over a long uselife. In addition, an ion-selective membrane in accordance with the invention contains relatively few components, making it simple and cost-effective to manufacture.

In general, in one aspect, the invention features a sensor for detecting one or more analytes in a sample that includes an electrode and an ion-selective membrane, wherein the ion selective membrane contains an epoxy resin and one or more amine curing agents. Embodiments of this aspect can include the following features. The analyte can be chloride ion. The sample can be a body fluid, such as blood, serum, plasma, cerebro-spinal fluid, saliva, or urine. The epoxy resin can include a bisphenol A epoxy resin. The amine curing agent can include tertiary amines, tertiary amine salts, aliphatic amines, cycloaliphatic amines, aromatic amines, amidoamines, imidazoles, polyimides, polyamines, and combinations thereof. The electrode can be a silver/silver chloride electrode.

In another aspect, the invention features a sensor card containing one or more of the sensors according to the invention.

In yet another aspect, the invention features a method of forming a sensor according to the invention. The method includes the steps of providing an electrode and applying to at least one surface of the electrode a membrane that includes an epoxy resin and one or more amine curing agents. In some embodiments, a solvent is added to the epoxy resin and the one or more amine curing agents to form a mixture, which is then applied to at least one surface of the electrode. The solvent can then be evaporated to form the ion-selective membrane.

In still another aspect, the invention features a method for detecting and/or measuring an analyte in a sample. The method includes the steps of providing a sensor that includes an electrode and an ion-selective membrane, wherein the ion selective membrane contains an epoxy resin and one or more amine curing agents; contacting the sensor with the sample; and detecting and/or measuring the analyte in the sample. The sample can be a body fluid, such as blood, serum, plasma, cerebro-spinal fluid, saliva, or urine. In certain embodiments, the analyte is chloride ion.

It should be understood that in any of the methods described and claimed herein, the steps can be performed in any order, or one or more steps can be performed simultaneously, as long as the invention remains operable.

### BRIEF DESCRIPTION OF THE DRAWINGS

The invention is pointed out with particularity in the appended claims. The aspects, features, and advantages of the invention can be better understood by reference to the description taken in conjunction with the accompanying drawings.

The drawings are not necessarily to scale, emphasis instead generally being placed upon illustrating the principles of the invention. In the drawings, like reference characters generally refer to the same parts throughout the different views.

FIG. 1 is a schematic cross-sectional view of an embodiment of a sensor according to the invention.

FIG. 2 is a schematic cross-sectional view of another embodiment of a sensor according to the invention.

FIG. 3 is a schematic top view of an embodiment of an electrode card according to the invention that includes one or more sensors according to the invention.

FIG. 4 is a schematic top view of an embodiment of an electrochemical sensor system according to the invention including a sensor cartridge with an electrode card and sample inlet, a peristaltic pump, and a microprocessor.

FIG. 5 is a graphical representation comparing chloride concentration values in whole blood samples as determined by five ISE sensors with ion-selective membranes containing an epoxy resin and an amine curing agent according to the invention to chloride concentration values in the same whole blood samples determined by a commercially-available chloride ISE sensor.

FIG. 6 is a graphical representation of the differences between successive chloride ion concentration values as determined by a chloride ISE sensor with an ion-selective membrane containing an epoxy resin and an amine curing agent according to the invention.

FIG. 7A is a graphical representation of the chloride concentration values of aqueous samples that also contain varying amounts of interfering species as determined by a commercially-available chloride ISE sensor (ABL-Cl), and five ISE sensors (Cl1-Cl5) with ion-selective membranes containing an epoxy resin and an amine curing agent according to the invention.

FIG. 7B is a graphical representation of the chloride concentration values of aqueous samples that also contain the same amounts of interfering species as the experiment illustrated by FIG. 7A, as determined by the same commercially-available chloride ISE sensor (ABL-Cl) and five ISE sensors (Cl1-Cl5), performed 24 days later.

FIG. 8 is a graphical representation comparing chloride concentration values in whole blood samples determined by four ISE sensors with ion-selective membranes containing different epoxy resins and amine curing agents according to the invention to the chloride concentration values in the same whole blood samples as determined by a commercially-available chloride ISE sensor.

### DESCRIPTION

The present invention provides ion-selective electrode (ISE) sensors for the potentiometric determination of one or more analytes in a biological sample, such as body fluids from a patient. Specifically, the invention pertains to a sensor having an ion-selective membrane that includes an epoxy resin and an amine curing agent. The sensor according to the invention can be configured to detect anions such as chloride, bromide, and/or thiocyanate ions, for example. In a particular embodiment, the sensor detects chloride ions in a sample.

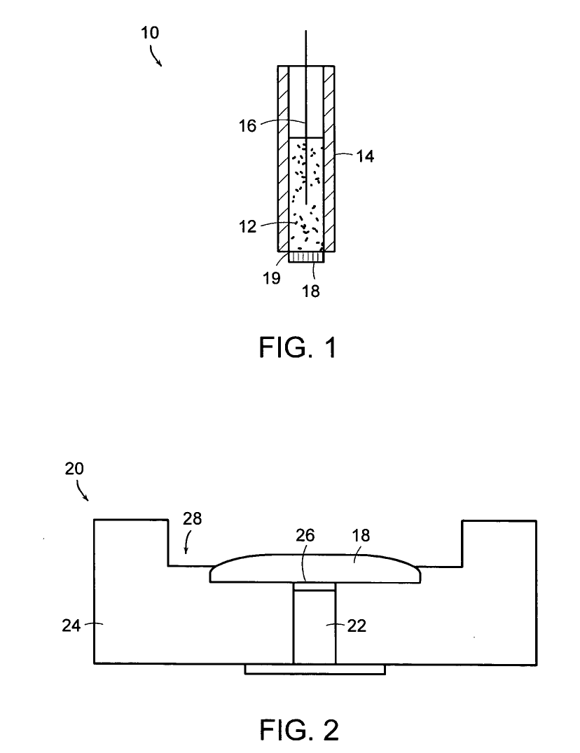

FIG. 1 illustrates a cross-sectional view of one embodiment of an ISE sensor 10 according to the invention, which includes an internal electrolyte 12 disposed within a housing 14, and an internal electrode 16 in contact with the internal electrolyte 12. An ion-selective membrane 18 covers an opening 19 in the housing 14 and separates the internal electrode 16 from an analytical sample, for example, a body fluid sample.

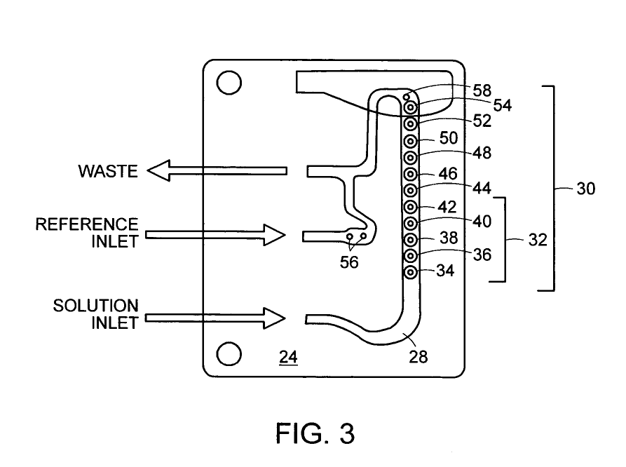

FIG. 2 illustrates a cross-sectional view of another embodiment of an ISE sensor 20 according to the invention, which includes an electrode 22 embedded within an electrode card 24. An ion-selective membrane 18 covers the exposed surface 26 of the electrode 22 and separates the electrode 22 from an analytical sample, for example, a body fluid sample, that passes through a channel 28 in the electrode card 24.

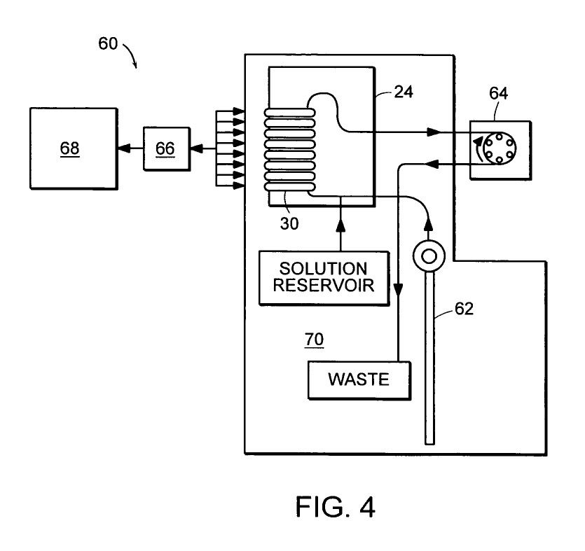

FIG. 3 illustrates a top view of an embodiment of an electrode card 24 that incorporates one or more of the embodiments of ISE sensors shown in FIG. 2. In one embodiment, the electrode card 24 includes a rigid, substantially rectangular substrate made of polyvinyl chloride (PVC). A channel 28 is located within the electrode card 24, through which a biological sample or a reference solution flows. One or more electrodes 30 can be embedded within the channel 28. When a sample is passed through the electrode card 24, it flows through the channel 28 and over the electrodes 30, allowing for detection and/or measurement of the analyte(s) of interest.

Referring to FIG. 3, according to one embodiment of the invention the electrodes 30 incorporated into the electrode card 24 include ISEs 32, electrodes for analyzing dissolved gases (gas electrodes), and electrodes which use an enzyme-based detection system (enzyme electrodes). For example, the electrodes detect chloride 34, sodium 36, potassium 38, calcium 40, pH 42, carbon dioxide 44, oxygen 46, glucose 48, lactate 50, creatinine 52, and urea 54. The electrode card 24 also includes a reference electrode 56 and a ground electrode 58.

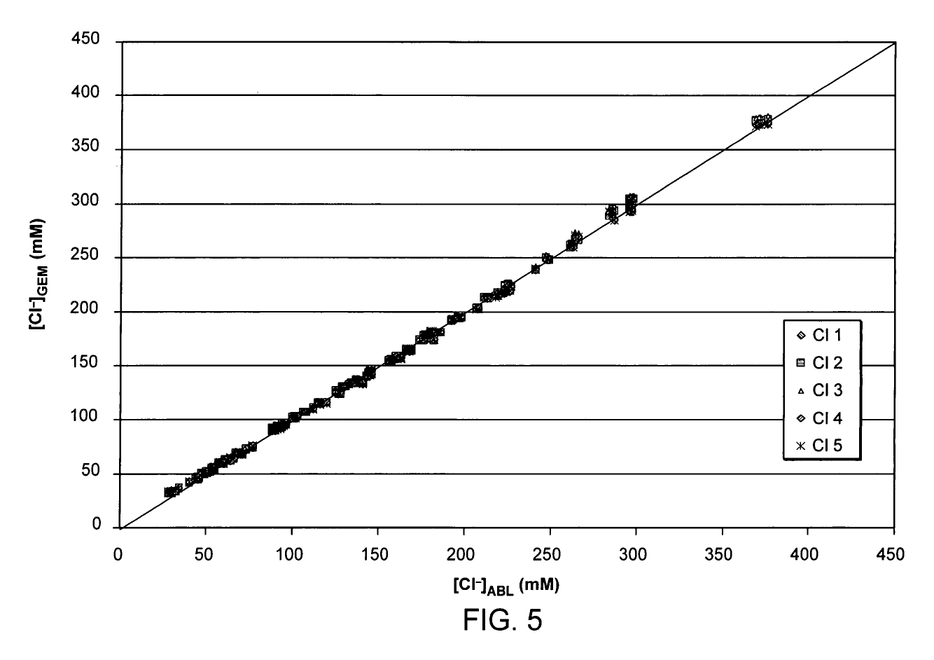

The sensor card 24 of FIG. 3 can be incorporated into an electrochemical sensor system for measuring one or more analytes in a biological sample, such as a body fluid sample. Referring to FIG. 4, in one embodiment according to the invention, an electrochemical sensor system 60 has an inlet 62 where the biological sample is introduced into the electrochemical sensor system 60. A peristaltic pump 64 moves the sample through the inlet 62 and into the electrode card 24, where it comes into contact with the one or more electrodes 30. An electrical interface 66 connects the electrode card 24 to a microprocessor 68. Signals from the electrode card 24 pass to the microprocessor 68 to allow for storage and display of the signals. Signals from the microprocessor 68 pass to the electrode card 24 to allow for control over measurement conditions, such as the polarization voltage of an electrode. In one embodiment according to the invention, the sample inlet 62 and the electrode card 24, as well as solution and waste reservoirs, are contained within a disposable cartridge 70, which can be detached from the remaining elements of the electrochemical sensor system 60 and replaced after use.

The electrochemical sensor system measures differences in the electric potential, measured in millivolts (mV), of an ISE sensor according to the invention across its ion-selective membrane due to the concentrations of analytes within a fluid sample. As practitioners skilled in the art are aware, electric potential values are related to the concentration and/or activity of ions in solution according to the Nernst equation. In a particular embodiment according to the invention, software may be included in an electrochemical sensor system to convert electrical potential values of an ISE sensor to concentration or activity values of the measured analyte by using the Nernst equation.

The ion-selective membrane according to the invention consists essentially of an epoxy resin and an amine curing agent. The epoxy resin imparts to the membrane a resistance to protein buildup during use. The amine curing agent both cures the polymeric membrane and acts as an ion-selective agent responsible for allowing selective permeation of the analyte of interest across the polymeric membrane. No further additives, such as, for example, additional ion-selective agents or flexibilizers, are needed for the proper function of ion-selective membranes according to the invention.

The epoxy resins according to the invention form a thin film of sufficient selectivity, when coupled with the amine curing agent, to allow a potential difference across the membrane, and are also sufficiently robust to maintain membrane integrity during repeated exposure to fluid samples. Suitable epoxy resins include glycidyl ethers of bisphenol A-epichlorohydrin. Bisphenol A-epichlorohydrin epoxy resins can be modified by blending with other resins, such as, for example, dibutyl phthalate, phenol-formaldehyde resins, amino resins, and/or acrylic resins, or by esterification with carboxylic acids. Epoxy resins can also include glycidyl ethers of epichlorohydrin and dihydric phenols, such as, for example, resorcinol, hydroquinone, p-p′-dihydroxydiphenylethane, bis-(2-hydroxynaphthyl)ethane, and 1,5-dihydroxynaphthalene. Other suitable glycidyl-ether resins include Novolak epoxies (e.g., epoxy phenol (EPN) and epoxy cresol (ECN) based resins), polyglycol epoxies, and halogenated epoxies (e.g., epoxies based on tetrabromobisphenol A and/or tetrachlorobisphenol A). Examples of other glycidyl epoxy resins include glycidyl-esters and glycidyl-amines (e.g., N,N,N′,N′-tetraglycidyl-4,4′-diaminodiphenylmethane). An ion-selective membrane according to the invention can also include non-glycidyl epoxy resins, such as cyclic aliphatic epoxies (e.g., 3,4-epoxy-6-methylcyclohexylmethyl-3,4-epoxy-6-methylcyclohexane carboxylate, 4-vinylcyclohexene dioxide, and dicyclopentadiene dioxide) and acyclic aliphatic epoxies (e.g., epoxidized oils and epoxidized diene polymers). Suitable epoxy resins have a molecular weight in the range of 100 to 10,000, preferably 200 to 5000, and more preferably 300 to 1000.

Amine curing agents cross-link epoxy resins to cure the polymer. Amine curing agents used in membranes according to the invention also selectively associate with the analyte of interest, for example, chloride ions, in the analytical sample to allow for ion exchange across the membrane. Suitable amine curing agents include tertiary amines and polyfunctional amines. Examples of tertiary amines used as curing agents for epoxy resins include benzyldimethylamine, 2-dimethylaminomethyl phenol, 2,4,6-tris(dimethylaminomethyl)phenol, triethanolamine, and N-n-butylimidazole. Salts of tertiary amines, such as the tri-2-ethylhexoate salt of 2,4,6-tris(dimethylaminomethyl)phenol, can also be used as amine curing agents in membranes according to the invention. Polyfunctional amines can be aliphatic, cycloaliphatic, or aromatic and generally include at least three reactive hydrogens present in primary and/or secondary amine groups. Examples of suitable polyfunctional amines include diethylenetriamine, triethylenetetramine, propoxylated triethylenetetramine, m-phenylenediamine, 4,4′-diaminodiphenylmethane, and 4,4′-diaminodiphenylsulfone. Other classes of suitable polyfunctional amines include amidoamines, imidazoles, polyimides, and polyamides (e.g., dimethylene propylene triamine polyamide). One type of polyamide, fatty polyamides, are obtained by the reaction of polyfunctional amines (such as ethylenediamine or diethylenetriamine) with dimerized and trimerized fatty acids. Polyfunctional amines that have fewer than three reactive hydrogens, such as diethanolamine, piperadine, and dimethylaminopropylamine, can also be used as amine curing agents in membranes according to the invention.

The chemical and physical characteristics of the polymeric membrane, such as ion selectivity, sensitivity, flexibility, and tensile strength, for example, can be controlled by the choice of the epoxy resin and amine curing agent, as well as the percentage of each component in the membrane. For example, an ion-selective membrane according to the invention contains from about 1% to about 80% by weight of an amine curing agent, preferably from about 5% to about 70%, and more preferably from about 10% to about 50%. In some embodiments according to the invention, the polymeric membrane includes more than one epoxy resin and/or more than one amine curing agent.

An ISE sensor according to the invention is resistant to protein buildup during repeated exposure to biological samples. In addition, the precision and accuracy of the ISE sensor according to the invention is comparable to a commercially-available ISE sensor, as illustrated by Examples 1, 2, and 5 below. The ISE sensor according to the invention exhibits selectivity for chloride ions in samples that contain various concentrations of interfering agents, as illustrated by Examples 3 and 4 below.

In another aspect, the invention provides a method of forming sensors according to the invention. Referring again to FIG. 2, in one embodiment according to the invention, an ion-selective membrane 18 is formed by applying a mixture of an epoxy resin and an amine curing agent to the exposed surface 26 of an electrode 22 embedded in an electrode card 24. The epoxy resin and the amine curing agent are mixed prior to application then applied to the exposed surface 26 of the electrode 22.

In other embodiments, a volatile solvent, typically tetrahydrofuran (THF) or cyclohexanone, is added to the epoxy resin and the amine curing agent, and the resulting mixture is applied to the electrode 22. Evaporation of substantially all of the solvent yields an ion-selective membrane 18 including an epoxy resin and an amine curing agent and no other additives disposed over the electrode 22. For example, a chloride ISE is fabricated by mixing a bisphenol A resin and a polyimide curing agent in THF, and applying a portion of the resulting mixture to the exposed end 26 of a silver/silver chloride electrode 22 embedded in the electrode card 24. The solvent is evaporated either at room temperature or by gentle heating (e.g., at about 40° C.). In some embodiments, additional portions of the membrane solution are applied with adequate drying in between each application. Evaporation of the solvent after the final application yields the ion-selective membrane 18 including an epoxy resin and an amine curing agent and no other additives bonded to the electrode card 24.

In another embodiment, an ion-selective membrane is formed by adding a mixture of the epoxy resin and the amine curing agent to a mold and allowing sufficient time for the polymer mixture to cure in the mold. In a variation of this embodiment, a volatile solvent is added to the epoxy resin/amine curing agent mixture, and the solvent is evaporated as the polymer mixture cures in the mold. The cured polymeric ion-selective membrane is then removed from the mold, cut to a desired shape, if necessary, and bonded in place over an electrode in an ISE sensor.

In another aspect, the invention provides a method for detecting the presence and/or measuring the concentration of an analyte in an analytical sample. In a particular embodiment of the invention, the analytical sample is a body fluid, such as blood, serum, plasma, cerebro-spinal fluid, saliva, or urine, for example. The method provides an ISE sensor that includes an electrode and an ion-selective membrane containing an epoxy resin and an amine curing agent and no other additives. The ion-selective membrane is disposed between the electrode and an analytical sample which contains an analyte of interest. The ISE sensor is then contacted with the analytical sample. In some embodiments, an ISE sensor of the type illustrated in FIG. 1 is contacted with the analytical sample by submerging at least a portion of the ISE sensor in the sample. In other embodiments, the analytical sample is applied to or flows over an ISE sensor of the type illustrated in FIG. 2. For example, the analytical sample is introduced into an electrode card 24, as illustrated in FIG. 3, where it flows over one or more electrodes 30 embedded within a channel 28 in the electrode card 24.

The following examples are intended to illustrate, but not limit, the invention.

### EXAMPLE 1

The accuracy of chloride ISE sensors according to the invention was determined by comparing the results obtained by the chloride ISE sensors according to the invention to the results obtained by a commercially-available chloride ISE sensor. A chloride ISE membrane mixture was prepared by mixing 0.75 mg Epoxy 907 resin and 0.75 mg Epoxy 907 curing agent (Miller-Stephenson Chemical, Danbury, Conn.) in 1.0 mL THF according to the invention. Five individual chloride ISE sensors were fabricated in the same manner by applying about 1 μL to about 3 μL of the membrane mixture to the exposed end of five silver/silver chloride electrodes embedded in a PVC electrode card using a syringe. The solvent was evaporated from each sensor by heating the electrode card to 40° C. for three hours and then letting the card stand at room temperature overnight.

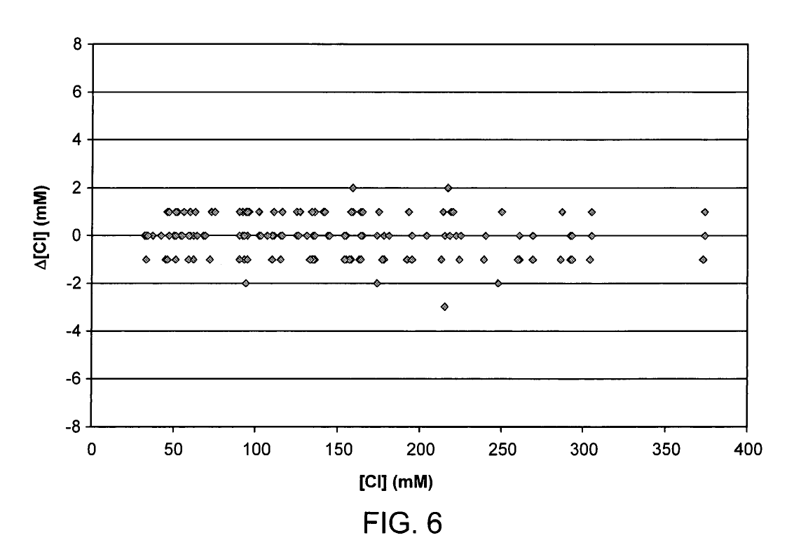

The chloride ion concentrations of 377 blood samples with chloride concentrations varying from 30 mmol/L to 370 mmol/L were determined using the five chloride ISE sensors according to the invention described above. For comparison, the same blood samples were analyzed using a commercially available chloride sensor (ABL 605, Radiometer Medical A/S, Copenhagen, Denmark) that includes an ion-selective membrane containing polyvinyl chloride (PVC) and a chloride ion-exchanger, and a cellophane membrane covering the ion-selective membrane. FIG. 5 is a graphical representation comparing the chloride concentration values determined by the five chloride ISE sensors according to the invention against the values determined by the commercially-available chloride ISE sensor. As FIG. 5 illustrates, the values obtained from the five chloride ISE sensors correlate well with those obtained using the known sensor, indicating that the accuracy of chloride concentration measurements made by chloride ISE sensors that contain ion-selective membranes consisting essentially of an epoxy resin, an amine curing agent, and no other additives are at least as accurate as those obtained from a known chloride ISE sensor that includes a PVC membrane.

### EXAMPLE 2

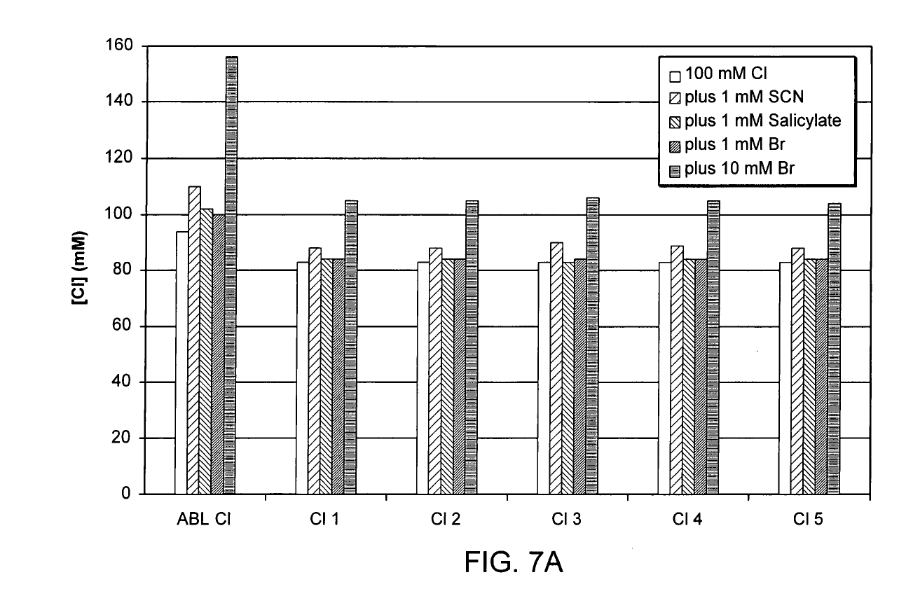

The precision of chloride ISE sensors according to the invention was determined by analyzing blood samples having known chloride concentrations in duplicate and comparing the results of each experiment. The chloride ion concentrations of 377 blood samples with chloride concentrations varying from 30 mmol/L to 370 mmol/L were determined using one of the five chloride ISE sensors of Example 1. Each blood sample was then analyzed again using the same ISE sensor, and the difference between the two measurements (Δ[Cl]) for each sample was calculated. FIG. 6 is a graphical representation of the Δ[Cl] value for each sample (y-axis) plotted against the average [Cl] value (x-axis) for each sample. As FIG. 6 illustrates, the chloride ion measurements generally fell within ±2 mmol/L for each sample, indicating that chloride ISE sensors that contain ion-selective membranes consisting essentially of an epoxy resin, an amine curing agent, and no other additives measure chloride ion concentrations in blood samples with high precision.

### EXAMPLE 3

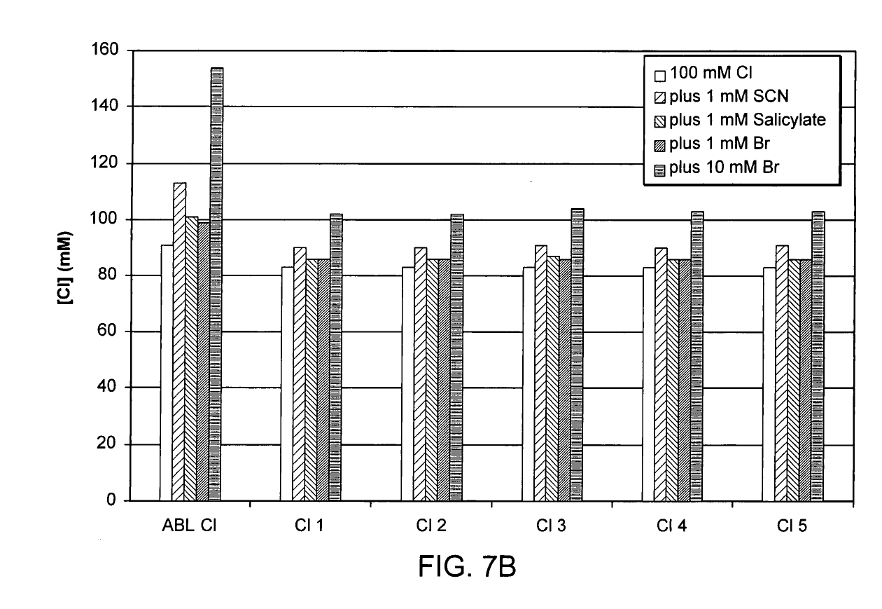

The selectivity of chloride ISE sensors according to the invention was examined by analyzing the chloride concentrations of aqueous samples that contain known concentrations of interfering ionic species. The chloride ion concentration value for an aqueous sample containing 100 mM chloride (Cl) was determined using the five chloride sensors according to the invention (Cl1-Cl5) and a commercially available chloride ISE sensor (ABL) that contains a PVC membrane, as described in Example 1. Next, the chloride ion concentration of an aqueous sample containing 100 mM chloride and 1 mM thiocyanate (SCN) was determined using each sensor, followed by aqueous samples containing 100 mM chloride and 1 mM salicylate, 100 mM chloride and 1 mM bromide (Br), and 100 mM chloride and 10 mM bromide. The results of the experiments for one of the five chloride ISE sensors according to the invention (Cl1) and the known chloride ISE sensor (ABL) are summarized in Table 1 below, and the results for all of the sensors are summarized graphically in FIG. 7A.

TABLE 1

| Sample | Sensor Cl1 [Cl] | ABL Sensor [Cl] |
|---|---|---|
| 100 mM Cl | 83 mM | 94 mM |
| 100 mM Cl + 1 mM SCN | 88 mM | 110 mM |
| 100 mM Cl + 1 mM Salicylate | 84 mM | 102 mM |
| 100 mM Cl + 1 mM Br | 84 mM | 100 mM |
| 100 mM Cl + 10 mM Br | 105 mM | 156 mM |

Aqueous samples containing the same five concentrations of chloride and interfering ionic species were tested 24 days later using the same sensors. The results for all of the sensors are summarized graphically in FIG. 7B.

As FIG. 7A illustrates, chloride ISE sensors according to the invention that contain ion-selective membranes consisting essentially of an epoxy resin, an amine curing agent, and no other additives exhibit improved selectivity for chloride ions in the presence of interfering ions compared to a known commercially-available chloride ISE sensor that contains a PVC membrane. Furthermore, as FIG. 7B illustrates, this improved selectivity over interfering ions does not diminish over time.

### EXAMPLE 4

Four chloride ISE sensors according to the invention were fabricated with ion-selective membranes made of the epoxy resins and amine curing agents (and no other additives) listed below:

| | |
|---|---|
| Sensor 1: | |
| Product Name: | Araldite AY103 & Hardener HY956 (Vantico Inc. |
| | North America, East Lansing, Michigan) |
| Epoxy Resin: | Bisphenol A diglycidyl ether, dibutyl phthalate |
| Amine | Diethylenetriamine, triethylenetetramine, |
| Curing Agent: | propoxylated triethylenetetramine |
| Resin:Amine:THF | 1.3:0.3:1 |
| ratio: | |
| Sensor 2: | |
| Product Name: | 5-Minute Epoxy (ITW Devcon, County Clare, |
| | Ireland) |
| Epoxy Resin: | Bisphenol A/epichlorohydrin |
| Amine | 2,4,6-tris(dimethylaminomethyl)phenol |
| Curing Agent: | |
| Resin:Amine:THF | 1.8:1.8:1 |
| ratio: | |
| Sensor 3: | |
| Product Name: | Deltabond 152 (Cast-Coat, Inc., Bridgewater, |
| | Massachusetts) |
| Epoxy Resin: | Bisphenol A/epichlorohydrin, n-butyl glycidyl ether |
| Amine | Deltabond 152-K-A |
| Curing Agent: | |
| Resin:Amine:THF | 10:1:5 |
| ratio: | |
| Sensor 4: | |
| Product Name: | Araldite 2011 AB (Vantico Inc. North America, |
| | East Lansing, Michigan) |
| Epoxy Resin: | Bisphenol A diglycidyl ether, phenyl glycidyl ether, |
| | dibutyl phthalate |
| Amine | Dimethylene propylene triamine, polyamide resin |
| Curing Agent: | |
| Resin:Amine:THF | 8:3:5 |
| ratio: | |

The chloride ion concentration value for an aqueous sample containing 100 mM chloride (Cl) was determined using each of Sensors 1-4 and a commercially available chloride ISE sensor (ABL) that contains a PVC membrane, as described in Example 1. Next, the chloride ion concentration of an aqueous sample containing 100 mM chloride and 1 mM thiocyanate (SCN) was determined using each sensor, followed by aqueous samples containing 100 mM chloride and 1 mM salicylate, 100 mM chloride and 1 mM bromide (Br), and 100 mM chloride and 10 mM bromide. The results of the experiments are summarized in Table 2 below.

TABLE 2

| | | | | | ABL |
|---|---|---|---|---|---|
| Sample | Sensor 1 | Sensor 2 | Sensor 3 | Sensor 4 | Sensor |
| 100 mM Cl | 97 mM | 100 mM | 100 mM | 101 mM | 97 mM |
| 100 mM | 109 mM | 112 mM | 101 mM | 104 mM | 102 mM |
| Cl + | | | | | |
| 1 mM | | | | | |
| SCN | | | | | |
| 100 mM | 98 mM | 104 mM | 101 mM | 103 mM | 98 mM |
| Cl + | | | | | |
| 1 mM | | | | | |
| Salicylate | | | | | |
| 100 mM | 105 mM | 104 mM | 108 mM | 103 mM | 103 mM |
| Cl + | | | | | |
| 1 mM Br | | | | | |
| 100 mM | 122 mM | 126 mM | 242 mM | 116 mM | 134 mM |
| Cl + | | | | | |
| 10 mM Br | | | | | |

As Table 2 illustrates, chloride ISE sensors according to the invention that contain ion-selective membranes consisting essentially of various epoxy resins, amine curing agents, and no other additives exhibit comparable or improved selectivity for chloride ions in aqueous samples that contain interfering ions as compared to a known chloride ISE sensor that contains a PVC membrane.

### EXAMPLE 5

The accuracy of the four chloride ISE sensors described in Example 4 was determined by comparing the results obtained by Sensors 1 4 to the results obtained by a commercially-available chloride ISE sensor that contains a PVC membrane, as described in Example 1.

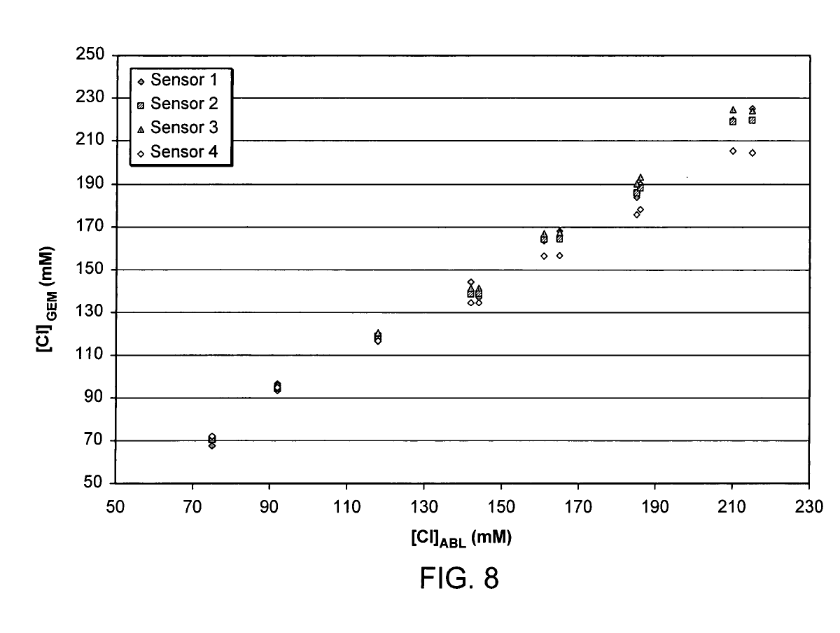

The chloride ion concentrations of 14 blood samples with chloride concentrations varying from 75 mmol/L to 210 mmol/L were determined using the four chloride ISE sensors described in Example 4. For comparison, the same blood samples were analyzed using a commercially available chloride sensor (ABL 605, Radiometer Medical A/S, Copenhagen, Denmark) that contains a PVC membrane, as described in Example 1. FIG. 8 is a graphical representation comparing the chloride concentration values determined by Sensors 1-4 against the values determined by the commercially-available chloride ISE sensor. As FIG. 8 illustrates, the values obtained from Sensors 1-4 correlate well with those obtained using the known sensor, indicating that the accuracy of chloride concentration measurements in blood samples made by chloride ISE sensors that contain ion-selective membranes consisting essentially of an epoxy resin, an amine curing agent, and no other additives are at least as accurate as those obtained from a known chloride ISE sensor that contains a PVC membrane.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. A sensor, comprising:
an electrode; and
an ion-selective membrane consisting essentially of an epoxy resin and one or more amine curing agents,
wherein the sensor detects or measures one or more analytes in a sample.

2. The sensor of claim 1, wherein the analyte is chloride ion.

3. The sensor of claim 1, wherein the epoxy resin comprises a bisphenol A epoxy resin.

4. The sensor of claim 1, wherein the amine curing agent is selected from the group consisting of tertiary amines, tertiary amine salts, aliphatic amines, cycloaliphatic amines, aromatic amines, amidoamines, imidazoles, polyimides, and polyamines.

5. The sensor of claim 1, wherein the electrode is a silver/silver chloride electrode.

6. The sensor of claim 1, wherein the sample is selected from the group consisting of blood, serum, plasma, cerebro-spinal fluid, saliva, and urine.

7. The sensor of claim 6, wherein the sample is blood.

8. A sensor card comprising:
a substrate; and
one or more sensors disposed on or in the substrate, the one or more sensors comprising:
an electrode, and
an ion-selective membrane consisting essentially of an epoxy resin and
one or more amine curing agents;
wherein the one or more sensors detect or measure one or more analytes in a sample.

9. The sensor card of claim 8, wherein the analyte comprises a chloride ion.

10. The sensor card of claim 8, wherein the epoxy resin comprises a bisphenol A epoxy resin.

11. The sensor card of claim 8, wherein the amine curing agent is selected from the group consisting of tertiary amines, tertiary amine salts, aliphatic amines, cycloaliphatic amines, aromatic amines, amidoamines, imidazoles, polyimides, and polyamines.

12. The sensor card of claim 8, wherein the electrode is a silver/silver chloride electrode.

13. The sensor of claim 8, wherein the sample is selected from the group consisting of blood, serum, plasma, cerebro-spinal fluid, saliva, and urine.

14. The sensor of claim 13, wherein the sample is blood.

15. A method of forming a sensor comprising the steps of:
providing an electrode; and
applying to at least one surface of the electrode a membrane consisting essentially of an epoxy resin and one or more amine curing agents,
wherein the sensor detects or measures one or more analytes in a sample.

16. The method of claim 15, wherein the applying step comprises:
combining the epoxy resin, the one or more amine curing agents, and a solvent to form a mixture, and
applying the mixture to at least one surface of the electrode.

17. The method of claim 16, further comprising the step of evaporating the solvent.

18. The method of claim 15, wherein the analyte comprises a chloride ion.

19. The method of claim 15, wherein the epoxy resin comprises a bisphenol A epoxy resin.

20. The method of claim 15, wherein the amine curing agent is selected from the group consisting of tertiary amines, tertiary amine salts, aliphatic amines, cycloaliphatic amines, aromatic amines, amidoamines, imidazoles, polyimides, and polyamines.

21. The method of claim 15, wherein the electrode is a silver/silver chloride electrode.

22. A method for detecting or measuring an analyte in a sample comprising:
providing a sensor comprising an electrode and an ion-selective membrane consisting essentially of an epoxy resin and one or more amine curing agents, wherein the ion-selective membrane is positioned between the electrode and a sample;
contacting the sensor with the sample; and
detecting or measuring the analyte in the sample.

23. The method of claim 22, wherein the analyte is chloride ion.

24. The method of claim 22, wherein the sample is selected from the group consisting of blood, serum, plasma, cerebro-spinal fluid, saliva, and urine.

25. The method of claim 24, wherein the sample is blood.

26. A sensor, comprising:
an electrode; and
an ion-selective membrane comprising an epoxy resin and one or more amine curing agents, but not any of the compounds selected from the group consisting of quaternary ammonium compounds, flexibilizers and polyvinyl chloride compounds,
wherein the sensor detects or measures one or more analytes in a sample.
